(19) United States
(12) Patent Application Publication
(10) Pub. No.: US 2018/0192090 A1
(43) Pub. Date: Jul. 5, 2018

(54) METHOD OF IMPLEMENTING AUDIO AND VIDEO LIVE BROADCAST AND SERVER

(71) Applicant: BEIJING BAIDU NETCOM SCIENCE AND TECHNOLOGY CO., LTD., Beijing (CN)

(72) Inventors: Huifeng SHEN, Beijing (CN); Jingbo Huang, Beijing (CN); Xu Li, Beijing (CN)

(73) Assignee: BEIJING BAIDU NETCOM SCIENCE AND TECHNOLOGY CO., LTD., Beijing (CN)

(21) Appl. No.: 15/860,606

(22) Filed: Jan. 2, 2018

(30) Foreign Application Priority Data
Jan. 4, 2017 (CN) 201710003522.0

(51) Int. Cl. H04N 21/231; H04N 21/2187; H04N 19/177; H04N 21/234; H04N 21/433; H04N 21/845; H04N 21/8547

(52) U.S. Cl. CPC H04N 21/23106; H04N 21/2187; H04N 19/177; H04N 21/8547; H04N 21/4331; H04N 21/8455; H04N 21/23406

(57) ABSTRACT

The present disclosure provides a method of implementing audio and video live broadcast and a server. The method comprises: when a new client accesses, amending buffered group of pictures GOP data closet to a current time by a principle of fast forward play; sending the amended GQP data to the client for play. The solution of the present disclosure can be used to improve live broadcast quality and the like.

The present application claims the priority of Chinese Patent Application No. 201710003522.0, filed on Jan. 4, 2017, with the title of “Method of implementing audio and video live broadcast and server”.

### FIELD OF THE DISCLOSURE

The present disclosure relates to Internet technologies, and particularly to a method of implementing audio and video live broadcast and a server.

### BACKGROUND OF THE DISCLOSURE

During audio and video live broadcast, first page opening time and end-to-end delay are two major indexes affecting a user's experience quality.

To reduce the first page opening time, the prior art usually employ the following processing manner: in a server is buffered GOP (Group of Pictures) data which is closest to the current time; when a new client accesses, all frames of data starting from the first frame of data in the buffered GOP data are sent to the client in turn, and the client begins to play from the first frame of data in the GOP data, thereby causing introduction of end-to-end delay of one GOP.

To reduce the end-to-end delay, the prior art usually employ the following processing manner: data buffering is not performed, and a newly-accessed client directly begins to play from the latest frame of data. However, since the latest frame of data is usually not a key frame and cannot decode and play independently, this causes block screen or blurred screen in a certain period of time, i.e., causes the first screen opening time too long and affects experience of the first screen.

It can be seen that in current manners, if the first screen opening time is reduced, the end-to-end delay is made longer; if the end-to-end delay is reduced, the first screen opening time is made longer. Either of the manners will reduce the live broadcast quality.

### SUMMARY OF THE DISCLOSURE

The present disclosure provides a method of implementing audio and video live broadcast and a server, which can improve live broadcast quality.

Specific technical solutions are as follows:

A method of implementing audio and video live broadcast, comprising:

when a new client accesses, amending buffered group of pictures GOP data closet to a current time by a principle of fast forward play;

sending the amended GOP data to the client for play.

According to a preferred embodiment of the present disclosure,

the GOP data comprises: I-frame data closest to the current time, and all frames of data from the I-frame data to the current time;

amending the GOP data comprises: performing timestamp compression for all frames of data in the GOP data in turn.

According to a preferred embodiment of the present disclosure,

before performing timestamp compression for all frames of data in the GOP data in turn, the method further comprises: discarding partial or all non-reference frames of data in the GOP data;

the performing timestamp compression for all frames of data in the GOP data in turn comprises: performing timestamp compression for remaining frames of data in the GOP data in turn.

According to a preferred embodiment of the present disclosure,

after sending the amended GOP data to the client for play, the method further comprises:

when new audio and video data is obtained, sending the audio and video data to the client for play.

According to a preferred embodiment of the present disclosure,

the method further comprises: creating a queue for the client;

the sending the amended GOP data to the client comprises:

placing the amended GOP data in the queue, and sending the data in the queue to the client;

the sending the audio and video data to the client comprises:

adding the audio and video data to the queue, and sending the data in the queue to the client.

A server, comprising: a processing unit and a sending unit;

the processing unit is configured to, when a new client accesses, amend buffered group of pictures GOP data closet to a current time by a principle of fast forward play, and send the amended GOP data to the sending unit;

the sending unit is configured to send the amended GOP data to the client for play.

According to a preferred embodiment of the present disclosure,

the GOP data include: I-frame data closest to the current time, and all frames of data from the I-frame data to the current time;

the processing unit comprise: a buffering sub-unit and an amending sub-unit;

the buffering sub-unit is configured to buffer the GOP data;

the amending sub-unit is configured to, when a new client accesses, obtain GOP data from the buffering sub-unit, perform timestamp compression for all frames of data in the GOP data in turn, and send the amended GOP data to the sending unit.

According to a preferred embodiment of the present disclosure,

the amending sub-unit is further configured to,

before performing timestamp compression for frames of data in the GOP data in turn, discard partial or all non-reference frames of data in the GOP data;

perform timestamp compression for remaining frames of data in the GOP data in turn.

According to a preferred embodiment of the present disclosure,

the processing unit further comprises an obtaining sub-unit;

the obtaining sub-unit is configured to, when new audio and video data are obtained, send the audio and video data to the sending unit.

According to a preferred embodiment of the present disclosure,

the sending unit is further configured to

create a queue for the client;

add both the received amended GOP data and the audio and video data to the queue;

send data in the queue to the client.

As can be seen from the above introduction, the solution of the present disclosure may be used to amend the buffered GOP data so that these data, upon reaching the client, can be fast forward played to minimize the end-to-end delay, and furthermore, reduce the first screen opening time by buffering the GOP data, and thereby improve live broadcast quality.

### BRIEF DESCRIPTION OF DRAWINGS

FIG. 1 is a flow chart of a method of implementing audio and video live broadcast according to the present disclosure;

FIG. 2 is a schematic diagram of a queue of the present disclosure;

FIG. 3 is a flow chart of a preferred embodiment of a method of implementing audio and video live broadcast according to the present disclosure;

FIG. 4 is a structural schematic view of a server according to the present disclosure.

### DETAILED DESCRIPTION OF PREFERRED EMBODIMENTS

Technical solutions of the present disclosure will be described in detail in conjunction with figures and embodiments to make technical solutions of the present disclosure clear and more apparent.

### Embodiment 1

FIG. 1 is a flow chart of an embodiment of a method of implementing audio and video live broadcast according to the present disclosure. As shown in FIG. 1, the embodiment comprises the following specific implementation manner:

At 11, when a new client accesses, buffered GOP data closet to a current time is amended by a principle of fast forward play;

At 12, the amended GOP data is sent to the client for play.

In practical application, a subject for executing the above 11 and 12 may be a server, for example, a stream media server.

It is feasible to buffer on the server the GOP data closest to the current time. Since the “current time” changes constantly, corresponding buffered GOP data also changes constantly.

The buffered GOP data may include: I-frame data closest to the current time, and all frames of data from the I-frame data to the current time.

As such, when a new client accesses, it is feasible to first obtain the GOP data closest to the current time and amend it so that these data may be fast forward played when sent to the client.

The amendment may be performed in the following manner: perform timestamp compression for all frames of data in the GOP data in turn.

For example, when a previous frame of data has a timestamp t, next frame of data has a timestamp t+33 ms (in the event of 30 fps) in the case of normal play, and then the timestamp of next frame of data may be amended to t+3.3 ms to implement time stamp compression.

Values to which timestamps of all frames of data are respectively amended may depend on actual needs. The faster a desired fast forward play speed is, the more the timestamps are compressed.

Since the first frame of data in the GOP data is the I-frame data, timestamp compression may not be preformed for the first frame of data, but performed for frames of data after the I-frame data in turn.

Through the timestamp compression, subsequent clients may achieve fast forward play, i.e., quicken a play speed of a section of video corresponding to the GOP data.

To further quicken the play speed, it is further feasible to, before performing timestamp compression, perform discard of non-reference frames of data, i.e., it is feasible to, after obtaining the GOP data closest to the current time, first discard partial or all non-reference frames of data therein, and then perform timestamp compression for remaining frames of data in the GOP data in turn.

Which non-reference frames of data are specifically discarded may depend on actual needs, for example, partial B-frame data may be discarded.

The GOP data may include three types of frames of data: I-frame data, P-frame data and B-frame data.

Wherein I-frame is a key frame, I-frame picture remains intact, and decoding may be completed only with the frame of data.

P frame is a fast forward prediction frame, and records a difference between this frame and one previous key frame or P frame. Upon decoding, the difference defined by this frame needs to be superimposed on the previously buffered pictures to generate a final picture.

B frame is a bidirectional interpolation frame and records a difference between the present frame and frames before and after it. In other words, when B frame needs to be decoded, it is necessary to obtain the previous buffered picture as well as the picture after the decoding, and obtain a final picture by superimposing the pictures before and after the decoding and the present frame of data.

Upon buffering the GOP data, audio data corresponding to the GOP data, namely, audio data starting from the time of I frame, may be buffered simultaneously. Since fast forward play exhibits a poor effect if there is sound, when the audio data corresponding to the GOP data is buffered, the audio data is usually discarded when the GOP data is amended, so the audio data may directly not be buffered.

The server may send the amended GOP data to the client for play. Then, when new audio and video data is obtained, namely, when new audio and video data reaches the server, the server may directly send the new audio and video data to the client for play.

In practical application, a queue may be created for each client. When a new client accesses, a queue may be created for it. When the amendment to GOP data is completed, it is feasible to add the amended GOP data to the queue, and send the data in the queue to the client. Likewise, when new audio and video data is obtained, it is feasible to add new audio and video data to the queue, and send the data in the queue to the client.

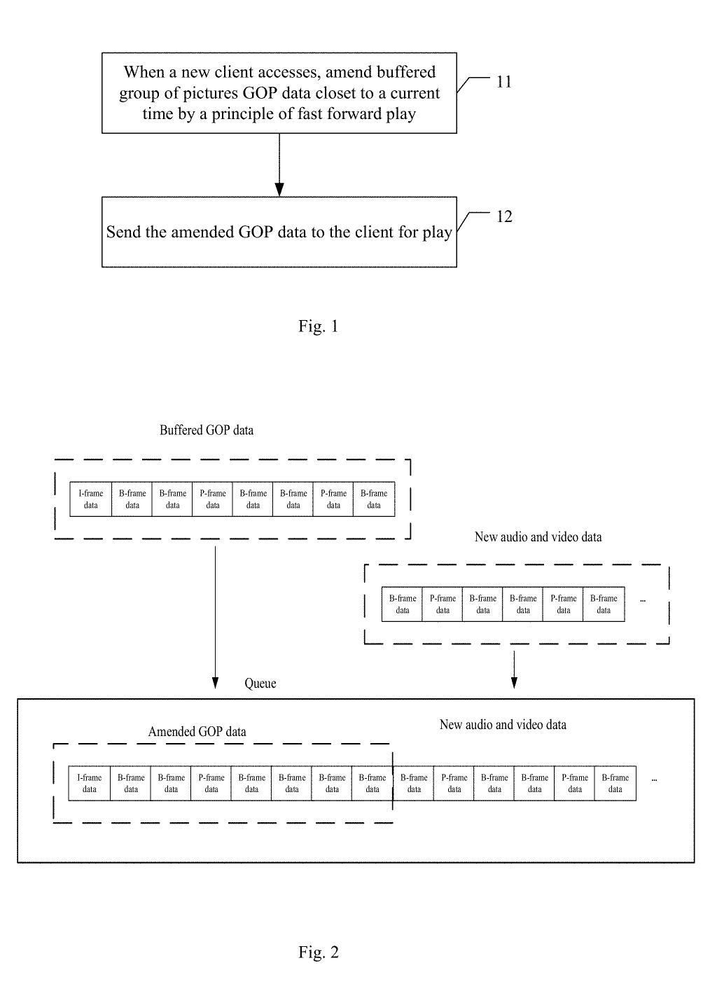

FIG. 2 is a schematic diagram of the queue of the present disclosure. As shown in FIG. 2, as for the same client, data to be sent to the client all are added into the queue corresponding thereto, and thereby the data in the queue are sent to the client.

### Embodiment 2

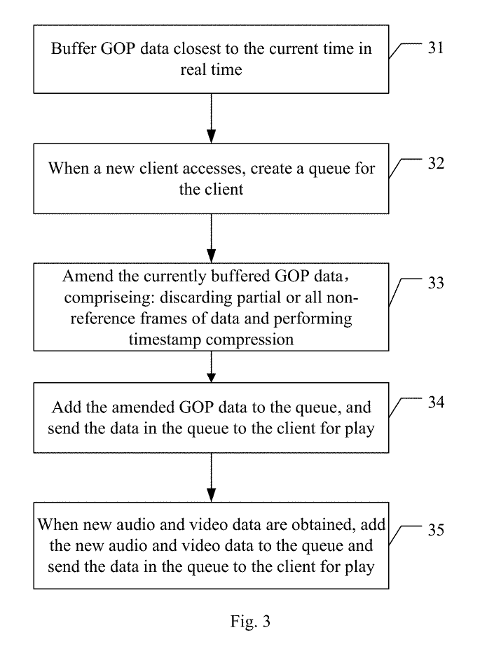

Based on the above introduction, FIG. 3 is a flow chart of a preferred embodiment of a method of implementing audio and video live broadcast according to the present disclosure. As shown in FIG. 3, the embodiment comprises the following specific implementation mode.

At 31, GOP data closest to the current time is buffered in real time.

At 32, when a new client accesses, a queue is created for the client.

At 33, amending the currently buffered GOP data comprises: discarding partial or all non-reference frames of data and performing timestamp compression.

At 34, the amended GOP data are added to the queue, and the data in the queue are sent to the client for play.

At 35, when new audio and video data are obtained, the new audio and video data are added to the queue and the data in the queue are sent to the client for play.

The above introduces method embodiments. The technical solution of the present disclosure will be further described below through an apparatus embodiment.

### Embodiment 3

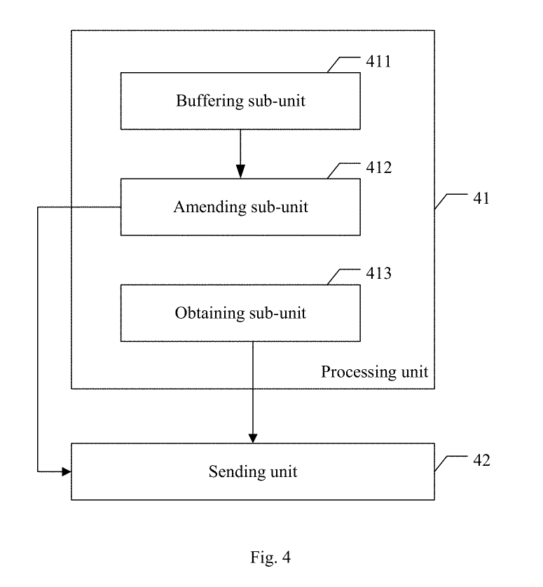

FIG. 4 is a structural schematic view of an embodiment of a server according to the present disclosure. As shown in FIG. 4, the server comprises: a processing unit 41 and a sending unit 42.

The processing unit 41 is configured to, when a new client accesses, amend buffered GOP data closet to a current time by a principle of fast forward play, and send the amended GOP data to the sending unit 42.

The sending unit 42 is configured to send the amended GOP data to the client for play.

Wherein the buffered GOP data may include: I-frame data closest to the current time, and all frames of data from the I-frame data to the current time.

Correspondingly, the processing unit 41 may specifically comprise: a buffering sub-unit 411 and an amending sub-unit 412.

The buffering sub-unit 411 is configured to buffer the GOP data. When the “current time” changes, the corresponding buffered GOP data also changes.

The amending sub-unit 412 is configured to, when a new client accesses, obtain GOP data from the buffering sub-unit 411, perform timestamp compression for all frames of data in the GOP data in turn, and send the amended GOP data to the sending unit 42.

Through the timestamp compression, subsequent clients may achieve fast forward play, i.e., quicken a play speed of a section of video corresponding to the GOP data.

To further quicken the play speed, it is further feasible to, before performing timestamp compression, perform discard of non-reference frames of data, i.e., it is feasible to, after obtaining the GOP data closest to the current time, first discard partial or all non-reference frames of data therein, and then perform timestamp compression for remaining frames of data in the GOP data in turn.

Correspondingly, the amending sub-unit 412 may be further configured to, before performing timestamp compression for frames of data in the GOP data in turn, discard partial or all non-reference frames of data in the GOP data, and then perform timestamp compression for remaining frames of data in the GOP data in turn.

Which non-reference frames of data are specifically discarded may depend on actual needs, for example, partial B-frame data may be discarded.

In addition, as shown in FIG. 4, the processing unit 41 may further comprise an obtaining sub-unit 413.

The obtaining sub-unit 413 is configured to, when new audio and video data are obtained, send the new audio and video data to the sending unit 42.

The sending unit 42 may create a queue for each accessed client, and add both the received amended GOP data and new audio and video data to the queue, and then send data in the queue to the client.

Reference may be made to corresponding depictions in the above-mentioned method embodiments for detailed workflow of the apparatus embodiment shown in FIG. 4, and no detailed depictions are presented any more here.

In one word, the solution of the present disclosure may be used to amend the buffered GOP data so that these data, upon reaching the client, can be fast forward played to minimize the end-to-end delay, and furthermore, reduce the first screen opening time by buffering the GOP data, and improve live broadcast quality by reducing the end-to-end delay and the first screen opening time.

Furthermore, in the solution of the present disclosure, what is employed is a chasing play technology of the server, which is completely compatible to the current video coding and decoding and video transmission protocols and does not require changes to the client.

In addition, the solution of the present disclosure is adapted for unidirectional audio and video live broadcast as well as interactive audio and video live broadcast, is applicable for service scenarios including game live broadcast, sport event live broadcast, activity live broadcast, beauty live broadcast and the like, and exhibits broad applicability.

In the embodiments provided by the present disclosure, it should be understood that the revealed apparatus and method can be implemented through other ways. For example, the above-described embodiments for the apparatus are only exemplary, e.g., the division of the units is merely a division in logical and function aspect, and, the units can be divided in other ways upon actual implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

What are stated above are only preferred embodiments of the present disclosure, not intended to limit the disclosure. Any modifications, equivalent replacements, improvements and the like made within the spirit and principles of the present disclosure, should all be included in the extent of protection of the present disclosure.

What is claimed is:

1. A method of implementing audio and video live broadcast, wherein the method comprises:
when a new client accesses, amending buffered group of pictures GOP data closet to a current time by a principle of fast forward play;
sending the amended GOP data to the client for play.

2. The method according to claim 1, wherein
the GOP data comprises: I-frame data closest to the current time, and all frames of data from the I-frame data to the current time;
amending the GOP data comprises: performing timestamp compression for all frames of data in the GOP data in turn.

3. The method according to claim 2, wherein,
before performing timestamp compression for all frames of data in the GOP data in turn, the method further comprises: discarding partial or all non-reference frames of data in the GOP data;
the performing timestamp compression for all frames of data in the GOP data in turn comprises: performing timestamp compression for remaining frames of data in the GOP data in turn.

4. The method according to claim 1, wherein
after sending the amended GOP data to the client for play, the method further comprises:
when new audio and video data is obtained, sending the audio and video data to the client for play.

5. The method according to claim 4, wherein
the method further comprises: creating a queue for the client;
the sending the amended GOP data to the client comprises:
placing the amended GOP data in the queue, and sending the data in the queue to the client;
the sending the audio and video data to the client comprises:
adding the audio and video data to the queue, and sending the data in the queue to the client.

6-10. (canceled)

11. A device, wherein the device comprises:
one or more processors;
a memory;
one or more programs stored in the memory and configured to execute the following operation when executed by the one or more processors:
when a new client accesses, amending buffered group of pictures GOP data closet to a current time by a principle of fast forward play;
sending the amended GOP data to the client for play.

12. The device according to claim 11, wherein
the GOP data comprises: I-frame data closest to the current time, and all frames of data from the I-frame data to the current time;
amending the GOP data comprises: performing timestamp compression for all frames of data in the GOP data in turn.

13. The device according to claim 12, wherein
before performing timestamp compression for all frames of data in the GOP data in turn, the operation further comprises: discarding partial or all non-reference frames of data in the GOP data;
the performing timestamp compression for all frames of data in the GOP data in turn comprises: performing timestamp compression for remaining frames of data in the GOP data in turn.

14. The device according to claim 11, wherein
after sending the amended GOP data to the client for play, the operation further comprises:
when new audio and video data is obtained, sending the audio and video data to the client for play.

15. The device according to claim 14, wherein
the operation further comprises: creating a queue for the client;
the sending the amended GOP data to the client comprises:
placing the amended GOP data in the queue, and sending the data in the queue to the client;
the sending the audio and video data to the client comprises:
adding the audio and video data to the queue, and sending the data in the queue to the client.

16. A non-volatile computer storage medium in which one or more programs are stored, an apparatus being enabled to execute the following operation when said one or more programs are executed by the apparatus:
when a new client accesses, amending buffered group of pictures GOP data closet to a current time by a principle of fast forward play;
sending the amended GOP data to the client for play.

17. The non-volatile computer storage medium according to claim 16, wherein
the GOP data comprises: I-frame data closest to the current time, and all frames of data from the I-frame data to the current time;
amending the GOP data comprises: performing timestamp compression for all frames of data in the GOP data in turn.

18. The non-volatile computer storage medium according to claim 17, wherein
before performing timestamp compression for all frames of data in the GOP data in turn, the operation further comprises: discarding partial or all non-reference frames of data in the GOP data;
the performing timestamp compression for all frames of data in the GOP data in turn comprises: performing timestamp compression for remaining frames of data in the GOP data in turn.

19. The non-volatile computer storage medium according to claim 16, wherein
after sending the amended GOP data to the client for play, the operation further comprises:
when new audio and video data is obtained, sending the audio and video data to the client for play.

20. The non-volatile computer storage medium according to claim 19, wherein
the operation further comprises: creating a queue for the client;
the sending the amended GOP data to the client comprises:
placing the amended GOP data in the queue, and sending the data in the queue to the client;
the sending the audio and video data to the client comprises:
adding the audio and video data to the queue, and sending the data in the queue to the client.
